(19) United States
(12) Patent Application Publication
(10) Pub. No.: US 2024/0405291 A1
(43) Pub. Date: Dec. 5, 2024

(54) ELECTRODE FILM ROLLED WEB, ELECTRODE, ELECTRODE LAMINATE, ELECTROCHEMICAL DEVICE, AND APPARATUS

(71) Applicant: FUJIMORI KOGYO CO., LTD., Tokyo (JP)

(72) Inventors: Takuo YONEDA, Tokyo (JP); Mitsuru TOKURA, Tokyo (JP); Yasuki HIRATA, Tokyo (JP); Ayumi ANDOU, Tokyo (JP); Tsutomu HAYASHI, Tokyo (JP); Hisashi NAKAZAWA, Tokyo (JP)

(21) Appl. No.: 18/674,005

(22) Filed: May 24, 2024

(30) Foreign Application Priority Data
May 29, 2023 (JP) 2023-087956

(51) Int. Cl. H01M 10/0587; H01M 4/36; H01M 4/62; H01M 10/0525

(52) U.S. Cl. CPC H01M 10/0587; H01M 4/364; H01M 4/623; H01M 10/0525

(57) ABSTRACT

The present invention relates to a novel electrode film rolled web for use as a material for an electrode, an electrode, an electrode laminate, an electrochemical device, and an apparatus for which such an electrode film rolled web is used as a material.

### CROSS-REFERENCE TO RELATED APPLICATIONS

This application claims the priority based on Japanese Patent Application No. 2023-087956 filed on May 29, 2023, the entirety of which is incorporated herein by reference.

### BACKGROUND

### Technical Field

The present invention relates to an electrode film rolled web, an electrode, an electrode laminate, an electrochemical device, and an apparatus.

### Related Art

In recent years, the importance of secondary batteries for use as power sources has been increased. Secondary batteries have been actively researched and developed, from small batteries such as power sources for portable electronic apparatuses to medium and large batteries such as batteries for electric vehicles and household storage batteries.

Secondary batteries each have a pair of electrodes each including an active material and an electrolyte disposed between the electrodes. The pair of electrodes includes a positive electrode including a positive active material and a negative electrode including a negative active material. As these electrodes, configurations are known, which have a laminate of an active material layer including a positive active material or a negative active material, and a current collector with excellent conductivity.

The active material layer mentioned above is formed by dispersing a powdery active material and a binder in a solvent to prepare a mixture in the form of slurry, coating the current collector with the obtained mixture, and pressing the current collector with the mixture thereon. The laminate of the active material layer and the current collector is cut into a desired battery shape, and used as an electrode (see, for example, Japanese Unexamined Patent Application, First Publication No. 2019-169444).

### SUMMARY

As described above, multistage processing such as preparing the mixture, coating with the mixture, drying, and pressing is necessary in order to fabricate the electrode. For simplifying the manufacturing process for secondary batteries and reducing the manufacturing cost, there is room for contrivance in terms of material.

The present invention has been made in view of such circumstances, and an object of the invention is to provide a novel electrode film rolled web for use as a material for an electrode. In addition, another object of the present invention is to provide an electrode, an electrode laminate, an electrochemical device, and an apparatus for which such an electrode film rolled web is used as a material.

The inventors have considered that if a material that has characteristics for being usable as an electrode can be achieved without using any current collector, processes such as preparing a mixture and coating a current collector with a mixture as described above can be omitted. In addition, the material in a film shape is considered to allow an electrochemical device to be easily manufactured by cutting the film (electrode film rolled web) and bonding the film to a battery element.

In addition, when the electrode film rolled web described above is assumed to be used as a positive electrode, the electrode film rolled web will include a positive active material. Common positive active materials are metal oxides, and thus hard and brittle. Accordingly, the inventors have been concerned that the electrode film rolled web including the positive active material may reflect the properties of the positive active material, and become brittle and difficult to handle.

From the viewpoints mentioned above, the inventors have intensively studied electrode film rolled webs that are easy to handle, and achieved the invention. For solving the problems mentioned above, an aspect of the present invention includes the following aspects.

[1] An electrode film rolled web including a mixture including an active material and a binder, where the electrode film rolled web satisfies the following (1) to (3):

(1) The breaking strength determined by the following measurement method is 0.35 MPa or more, and the elongation percentage is 3% or more at the breaking strength.

(Measurement Method) The strength of 75% of the maximum stress is defined as breaking strength, when a test piece obtained by cutting the electrode film rolled web into a size of 15 mm in width and 50 mm in length is measured under the conditions of inter-chuck distance: 30 mm and tensile speed: 100 mm/min.

(2) The binder contains a styrene butadiene rubber, a polyvinylidene fluoride, and a polycarboxylic acid polymer.

(3) The binder satisfies all of the following content ratios with respect to the whole mixture.

Total amount of binder: more than 1.8% by mass and 6.5% by mass or less

Styrene butadiene rubber: more than 0.6% by mass and 1.5% by mass or less

Polycarboxylic acid polymer: 0.4% by mass or more and 2.6% by mass or less

[2] An electrode film rolled web including an active material layer including, as a material, a mixture including an active material and a binder, and including no current collector, where the electrode film rolled web satisfies the following (1) to (3):

(1) The breaking strength determined by the following measurement method is 0.35 MPa or more, and the elongation percentage is 3% or more at the breaking strength.

(Measurement Method) The strength of 75% of the maximum stress is defined as breaking strength, when a test piece obtained by cutting the electrode film rolled web into a size of 15 mm in width and 50 mm in length is measured under the conditions of inter-chuck distance: 30 mm and tensile speed: 100 mm/min.

(2) The binder contains a styrene butadiene rubber, a polyvinylidene fluoride, and a polycarboxylic acid polymer.

(3) The binder satisfies all of the following content ratios with respect to the whole mixture.

Total amount of binder: more than 1.8% by mass and 6.5% by mass or less

Styrene butadiene rubber: more than 0.6% by mass and 1.5% by mass or less

Polycarboxylic acid polymer: 0.4% by mass or more and 2.6% by mass or less

[3] The electrode film rolled web according to [1] or [2], where the mixture may include a conductive material in an amount of 2% by mass or more and 5% by mass or less with respect to the whole mixture.

[4] The electrode film rolled web according to any one of [1] to [3], where the polycarboxylic acid polymer may be a poly(meth)acrylic acid.

[5] The electrode film rolled web according to any one of [1] to [4], where a release film may be laminated.

[6] An electrode that may include the electrode film rolled web according to any one of [1] to [5] as a material.

[7] An electrode laminate where the electrode according to [6] and a separator or a solid electrolyte membrane may be laminated.

[8] An electrochemical device that may include the electrode laminate according to [7].

[9] An apparatus that may include the electrochemical device according to [8].

According to the present invention, a novel electrode film rolled web for use as a material for an electrode can be provided. In addition, an electrode, an electrode laminate, an electrochemical device, and an apparatus for which such an electrode film rolled web is used as a material can be provided.

### BRIEF DESCRIPTION OF DRAWINGS

FIG. 1 is a schematic view illustrating an electrode film rolled web 1 according to the present embodiment.

FIG. 2 is a schematic view illustrating how a bending test is performed.

FIG. 3 is a schematic view illustrating an electrode film rolled web 2 according to the present embodiment.

FIG. 4 is a schematic view of an electrochemical device 100 including an electrode laminate 50.

### DETAILED DESCRIPTION

### [Electrode Film Rolled Web and Electrode]

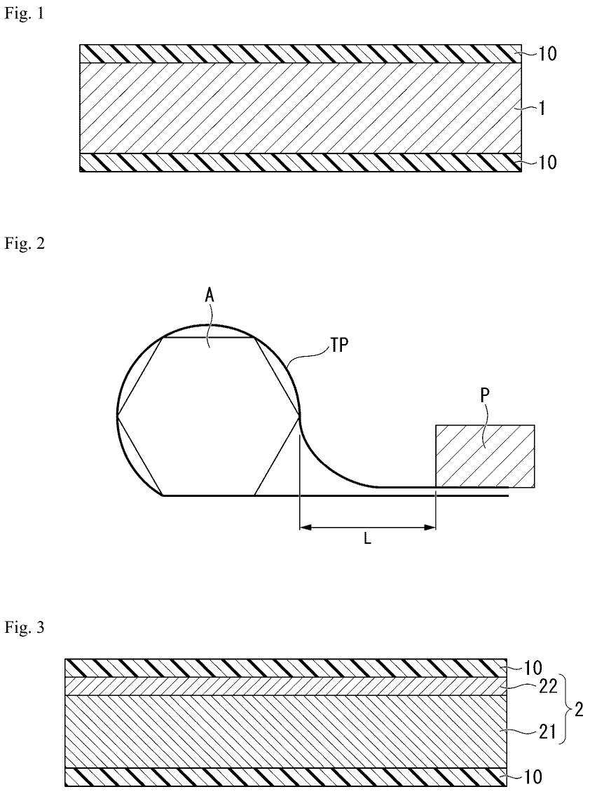

FIG. 1 is a schematic view illustrating an electrode film rolled web 1 according to the present embodiment.

The term “electrode film rolled web” refers to a film-shaped molded body before being processed into an electrode. Typically, the electrode film rolled web is a long molded body formed in a strip shape, or a sheet-shaped molded body obtained by sheet-fed processing such a strip-shaped molded body.

The electrode film rolled web 1 shown in FIG. 1 is sandwiched between release films 10 from both surfaces. As the release films 10, known materials such as a release-treated PET film can be employed.

The electrode film rolled web 1 includes a mixture containing an active material and a binder. The electrode film rolled web 1 has no current collector.

The electrode film rolled web 1 has characteristic functions of (a) being self-standing and (b) being usable as an electrode.

### (a) Self-Standing

The electrode film rolled web 1 can be cut into a desired shape to be processed into an electrode. The electrode film rolled web 1 may be used as an electrode as it is. The obtained electrode can maintain the cut shape without having any attachment such as a substrate. Having such a property may be referred to as “self-standing” or “self-standing type” in the present specification. In other words, the electrode film rolled web 1 has rigidity capable of existing without any support.

### (b) Usable as an Electrode

The electrode film rolled web 1 can be cut into a desired shape to be used as an electrode for an electrochemical device such as a secondary battery. More specifically, the electrode film rolled web 1 has low electron resistance to the extent that the web is usable as an electrode, and high ion conductivity.

The electrode obtained by cutting the electrode film rolled web 1 that has the functions of (a) and (b) is self-standing (a self-standing type electrode), and can be used as an electrode for an electrochemical device such as a secondary battery simply by bonding the electrode to a member of the electrochemical device.

Hereinafter, the respective configurations of the electrode film rolled web 1 will be sequentially described.

### (Active Material)

Powdery materials known as positive active materials for secondary batteries can be used as the active material.

In the case of employing a lithium ion secondary battery as the secondary battery, examples of the positive active material of the lithium ion secondary battery include at least one selected from materials such as composite oxides of lithium and a transition metal such as cobalt, manganese, and nickel, and polymers that have Li storage ability. The positive active material of the lithium ion secondary battery may be a compound that can be reversibly doped and dedoped with lithium ions.

Examples of the positive active material include a lithium cobalt oxide (LiCoO₂), a lithium manganese oxide (LiMnO₄), a lithium iron phosphate (LiFePO₄), a Ni—Co—Mn ternary (NCM-based) active material (LiNiₓMn_{y}Co_{z}O₂), and a Ni—Co—Al ternary (NCA-based) active material (LiNiₓCo_{y}Al_{z}O₂).

As the active material, a material with a volume average particle size of 0.1 to 100 μm is used.

### (Binder)

The binder is a material for use in binding particles such as an active material, and for example, a resin is used for the binder. As the binder, a known thermoplastic resin can be employed, which is used for the above-mentioned purpose as an electrode material.

Examples of the functions of the binder include (i) imparting high strength to the electrode film rolled web, (ii) adjusting the electrical resistance (reducing the resistance), and (iii) adjusting other physical properties, besides the above-described “binding particles such as an active material”. Binders that especially intensively have the functions of (i), (ii), and (iii) are referred to respectively as a “high-strength binder”, a “resistance adjusting binder”, and “other binders”, and will be described.

### ((i) High-Strength Binder)

As the high-strength binder, an elastomer can be used. The binder that has properties as an elastomer can impart flexibility and strength to the electrode, and can keep the electrode from being broken due to a change in the volume of the active material during use of the electrode.

The high-strength binder desirably has a tensile strength of 5 MPa or more. In addition, it is necessary for the high-strength binder to be stable against an electrolytic solution inside the electrochemical element (battery), and electrochemically stable.

In the method for measuring the tensile strength of the high-strength binder, the strength of 75% of the maximum stress is defined as breaking strength, when a test piece obtained by forming a film of only the high-strength binder and cutting the film into a size of 15 mm in width and 50 mm in length is measured under the conditions of inter-chuck distance: 30 mm and tensile speed: 100 mm/min.

For example, in the case of employing a lithium ion battery as the electrochemical element and using an electrode obtained by cutting the electrode film rolled web 1, it is necessary for the high-strength binder not to be eluted from the electrode into the electrolytic solution filling the battery. In addition, it is necessary for the high-strength binder not to undergo oxidative decomposition at 3 to 5 V (vs. Li/Li⁺).

For the tensile strength of the high-strength binder, a value measured by a method for measuring the breaking strength as described later is employed.

In the present embodiment, a styrene-butadiene copolymer (SBR) is used as the high-strength binder. The styrene-butadiene copolymer may be hydrogenated.

In addition, the binder may include, as the high-strength binder, the following copolymer containing styrene and a conjugated diene besides SBR.
Styrene-isoprene copolymer
Styrene-butadiene-methyl methacrylate copolymer (MBS)
Acrylonitrile-styrene-butadiene copolymer (ABS)
Acrylonitrile-styrene-butadiene-methyl methacrylate copolymer (MABS)
Carboxy-modified styrene butadiene rubber
Styrene-butadiene-styrene block copolymer (SBS)
Styrene-isoprene-styrene block copolymer (SIS)
Styrene-isoprene-butadiene-styrene block copolymer (SIBS)

The copolymers excluding SBR may be copolymerized with another copolymerizable vinyl-based monomer, or may be hydrogenated.

Examples of the vinyl-based monomer mentioned above include:
Acrylate-based monomer such as alkyl acrylate;
Methacrylate-based monomers such as alkyl methacrylates;
Acrylamide-based monomers such as alkoxyacrylamides;
Methacrylamide-based monomers such as alkoxymethacrylamides;
Carboxylic acid-based monomers such as acrylic acids;
Nitrile-based monomers such as acrylonitrile;
Vinyl ester-based monomers such as vinyl acetates;
Vinyl halide-based monomers such as vinyl chlorides; and
Polyfunctional monomers such as allyl acrylates.

One of these vinyl-based monomers may be copolymerized with the copolymer mentioned above, or two or more thereof may be copolymerized.

((ii) Resistance Adjusting Binder)

In the present embodiment, a polyvinylidene fluoride (PVdF) and a polycarboxylic acid polymer are used as the resistance adjusting binder.

The polyvinylidene fluoride is capable of slightly swelling an electrolytic solution described later. Thus, the polyvinylidene fluoride contributes to the formation of a diffusion path for lithium ions in the binder. In addition, the polyvinylidene fluoride can assist transport of lithium ions in the binder.

The polycarboxylic acid polymer contains: a polymer or copolymer of a monomer having a carboxyl group; and a copolymer of a monomer having a carboxyl group and a monomer having no carboxyl group. In addition, the polycarboxylic acid polymer is preferably a polymer obtained by polymerization with the use of a carbon-carbon unsaturated bond.

The monomer containing a carboxyl group is preferably a monomer having an unsaturated bond and a carboxyl group, such as a (meth)acrylic acid, a maleic acid, and a fumaric acid.

The monomer having no carboxyl group is preferably a monomer such as ethylene, propylene, 1-butene, and 2-butene.

As the polycarboxylic acid polymer, a polymer for which a (meth)acrylic acid is used as a monomer is preferable. Examples of such a polymer include a poly(meth)acrylic acid, a copolymer of a (meth)acrylic acid and a maleic acid, a copolymer of ethylene and a (meth)acrylic acid, and a copolymer of ethylene, a (meth)acrylic acid, and a maleic acid. Among these examples, a poly(meth)acrylic acid is preferable.

The (meth)acrylic acid means encompassing an acrylic acid and a methacrylic acid, and the poly(meth)acrylic acid means encompassing a polyacrylic acid, a polymethacrylic acid, and a copolymer of acrylic acid and methacrylic acid.

The polycarboxylic acid polymer is capable of exchanging cations in a carboxy group (—COOH) included in the molecule, and has lithium ion conductivity. Thus, the binder has a polycarboxylic acid polymer, thereby allowing the lithium ion conductivity of the binder to be improved, and allowing the resistance of the electrode film rolled web to be adjusted.

In addition, since the poly(meth)acrylic acid is softer and more likely to be deformed than the (i) a high-strength binder, the binder contains therein the poly(meth)acrylic acid, thereby allowing the flexibility of the electrode film rolled web to be enhanced.

In addition, the binder may contain, as the resistance adjusting binder, an acrylate-based binder and a polyimide-based binder besides PVdF and PAA. It is necessary for the resistance adjusting binder not to undergo oxidative decomposition at 3 to 5 V (vs. Li/Li⁺).

The (i) high-strength binder is considered electrochemically inactive, and when the active material is completely covered with the (i) high-strength binder, the electrochemical reaction of the active material is considered to fail to be developed, and the resistance of the electrode is considered to be increased. In contrast, the use of the (ii) resistance adjusting binder as described above in combination allows the resistance to be kept from being increased by covering the active material with the (i) high-strength binder.

((iii) Other Binders (Adhesive Binders))

As the adhesive binder, a resin material that has a reactive functional group or an anchor effect can be used. Examples of the reactive functional group include a hydroxyl group (—OH) and a carboxy group. When the electrode film rolled web contains such a binder, in bonding an electrode obtained from the electrode film rolled web to another member, the reactive functional group can be expected to react at the bonded surface to increase the adhesive strength.

In addition, the electrode film rolled web contains the adhesive binder, thereby making a self-standing type electrode produced from the electrode film rolled web likely to adhere to another member.

Desirably, the adhesive binder is electrochemically stable and has adhesiveness even when the binder is exposed to other members, especially an electrolytic solution. For example, in the case of employing a lithium ion battery as an

electrochemical element and using an electrode obtained by cutting the electrode film rolled web 1, it is necessary for the adhesive binder not to be eluted from the electrode into an electrolytic solution filling the battery, and it is necessary for the reactive functional group to be unlikely to be deactivated even when the binder is exposed to the electrolytic solution.

In addition, it is necessary for the adhesive binder not to undergo oxidative decomposition at 3 to 5 V (vs. Li/Li⁺).

Examples of such a binder include at least one selected from carboxymethyl cellulose (CMC) based binders, vinyl alcohol-based binders, and epoxy-based binders. In addition, the PAA mentioned as the (ii) resistance adjusting binder also contributes to an improvement in adhesive strength.

In addition, polyisobutylene (PIB) can also be used as the adhesive binder.

The mixture constituting the electrode film rolled web may contain, besides the above-described active material and binder, an additive such as a conductive material, as necessary, for adjusting the physical properties. Examples of the conductive material include at least one selected from materials, for example, carbon black such as acetylene black and Ketjen black (registered trademark), carbon fibers, activated carbon, metal powders, and conductive polymers. It is not necessary for the conductive material to have any activity like the active material, and may be any material that improves the conductivity inside the electrode.

In addition, the mixture constituting the electrode film rolled web may contain carbon nanotubes (CNT) as a conductive material. The electrode film rolled web with CNTs added thereto can be expected to have an improvement in breaking strength and an improvement in conductivity.

Ketjen black is preferable as the conductive material. Ketjen black is conductive carbon that has higher conductivity than other carbon blacks, and a smaller amount of Ketjen black used is capable of achieving equivalent conductivity than other carbon blacks.

In contrast, since Ketjen black has a hollow shell-shaped structure, the mechanical strength of the electrode film rolled web containing Ketjen black is likely to be decreased. In the electrode film rolled web according to the present embodiment, the binder contains SBR that is excellent in mechanical strength as in the requirements (2) and (3) described later, thus allowing the shortage of the mechanical strength to be compensated even when Ketjen black is used.

In addition, the thickness of the electrode film rolled web is preferably 1 μm or more and 1000 μm or less.

The electrode film rolled web including a mixture of the materials mentioned above satisfies the following requirements (1) to (3) for exhibiting the functions (a) and (b) mentioned above.

### (Requirement (1))

As described above, the electrode film rolled web 1 has the feature of “(a) being self-standing”. The electrode film rolled web 1 with such rigidity has a breaking strength of 0.35 MPa or more as determined by the following measurement method.

In addition, the electrode film rolled web 1 is preferably less likely to be cracked or broken, for example, when the electrode film rolled web 1 is wound up or when an electrode cut out from the electrode film rolled web 1 is bent, and easy to handle. Accordingly, the electrode film rolled web 1 has an elongation percentage of 3% or more at the breaking strength.

### (Method for Measuring Breaking Strength and Elongation Percentage)

The strength of 75% of the maximum stress is defined as breaking strength, when a test piece obtained by cutting the electrode film rolled web into a size of 15 mm in width and 50 mm in length is measured under the conditions of inter-chuck distance: 30 mm and tensile speed: 100 mm/min.

In addition, the elongation percentage is determined by the following formula (1) from the inter-chuck distance of the test piece at the breaking strength.

$$Elongation Percentage ( \% ) = ( L 1 - L 0 ) / L 0 \times 100 \qquad ( 1 )$$

L0: initial value of inter-chuck distance (30 mm)
L1: inter-chuck distance at breaking strength

The magnitude of the tensile force (N) on the breakage of the test piece is defined as the maximum stress, and the stress of 75% of the maximum stress is determined. The value (N/mm²=MPa) obtained by dividing the stress (N) of 75% by the cross-sectional area (mm²) of the test piece in an imaginary plane orthogonal to the tensile direction is determined as the breaking strength.

The arithmetic mean value of measured values obtained by performing the above-mentioned measurement three times is employed for the breaking strength in the present specification.

The electrode film rolled web has such breaking strength, thereby allowing an electrode cut from the electrode film rolled web to be self-standing. Allowing the electrode to be self-standing makes it easy to handle the electrode in the subsequent assembly process.

The breaking strength is preferably 0.4 MPa or more, more preferably 0.5 MPa or more. In addition, the breaking strength can be considered preferably higher because the web is less likely to be broken, but the breaking strength may be 10 MPa or less, and may be 5 MPa or less.

In addition, the electrode film rolled web 1 has a feature of being unlikely to be cracked or broken when the web is deformed such as wound up or bent, and being easy to handle. In curving the electrode film rolled web 1, tensile stress is applied to the outer surface of the curved film. In this case, the electrode film rolled web 1 has an elongation percentage of 3% or more at the breaking strength, thereby making the web less likely to be cracked or broken by the tensile stress generated at the time of curving the web, and making it easy to handle the web.

The arithmetic mean value of measured values obtained by performing the above-mentioned measurement three times is adopted for the elongation percentage in the present specification.

The elongation percentage is preferably 3.5% or more, more preferably 4% or more. In addition, the elongation percentage can be considered preferably higher because the web is less likely to be broken, but the breaking strength may be 10% or less, and may be 8% or less.

In addition, the strength of the electrode film rolled web 1 against bending can also be confirmed by the following bending test. FIG. 2 is a schematic view illustrating how a bending test is performed.

### (Bending Test)

The electrode film rolled web is cut to prepare a test piece TP of 50 mm×120 mm. In the longitudinal direction of the obtained test piece TP, the test piece TP is wound around a hexagonal prism-shaped test tool A that has a regular hexagonal cross-sectional shape. The distance between two parallel faces of the test tool A is 2 mm. As the test tool A, a hexagonal wrench of 2 mm in width across flats as specified in JIS B 4648 can be used.

Both ends of the test piece TP are overlapped with each other, and the end of the test piece TP is pressed with a rectangular metal plate P that is wider than the test piece TP. When the metal plate P is brought close to 2.2 mm (L=2.2 mm) from the test tool A, the uncracked test piece TP is determined to be a good product, and the cracked test piece TP is determined to be a defective product.

### (Requirements (2) and (3))

As described above, the electrode film rolled web 1 has the feature of “(b) being usable as an electrode”. The electrode film rolled web 1 with such properties satisfies the following requirements (2) and (3):

Requirement (2): The binder contains a styrene butadiene rubber, a polyvinylidene fluoride, and a polycarboxylic acid polymer.

Requirement (3): The binder satisfies the following content ratios with respect to the whole mixture.

Total amount of binder: more than 1.8% by mass and 6.5% by mass or less

Styrene butadiene rubber: more than 0.6% by mass and 1.5% by mass or less

Polycarboxylic acid polymer: 0.4% by mass or more and 2.6% by mass or less

In addition, the content ratio of the PVdF with respect to the whole mixture is 0.4% by mass or more and 2.6% by mass or less.

As long as the requirements (2) and (3) are satisfied, the composition of the binder can be appropriately adjusted depending on the requested physical properties of the electrode film rolled web to be produced.

For example, the content ratio of the binder may be 2.0% by mass or more, or 2.5% by mass or more with respect to the whole mixture. In addition, the content ratio of the binder may be 6.0% by mass or less, 5.0% by mass or less, or 4.0% by mass or less. The upper limit and lower limit of the total amount of the binder can be arbitrarily combined.

When the total amount of the binder is increased, the mechanical strength tends to be improved. In addition, when the amount of the active material is reduced instead of increasing the total amount of the binder, the capacity retention ratio tends to be decreased.

The content ratio of the SBR may be 0.8% by mass or more, or 1.0% by mass or more with respect to the whole mixture. In addition, the content ratio of the SBR may be 1.4% by mass or less, or 1.2% by mass or less. The upper limit and lower limit of the content ratio of the SBR can be arbitrarily combined.

When the content ratio of the SBR is increased with the total amount of binder kept constant, the tensile strength tends to be improved, and the capacity retention ratio tends to be decreased due to the high insulating property of the SBR.

The content ratio of the polycarboxylic acid polymer may be 0.6% by mass or more, 0.8% by mass or more, or 1.0% by mass or more with respect to the whole mixture. In addition, the content ratio of the polycarboxylic acid polymer may be 2.4% by mass or less, 2.0% by mass or less, or 1.6% by mass or less. The upper limit and lower limit of the content ratio of the polycarboxylic acid polymer can be arbitrarily combined.

When the content ratio of the polycarboxylic acid polymer is increased with the total amount of the binder kept constant, the elongation percentage tends to be improved due to the high flexibility of the polycarboxylic acid polymer, and the capacity retention ratio tends to be improved due to the electrical characteristics of the polycarboxylic acid polymer.

In contrast, when the content ratio of the polycarboxylic acid polymer is excessively high, the whole binder is excessively softened, and the processing accuracy in processing the electrode film rolled web to prepare an electrode is likely to be degraded. In addition, when the content ratio of the polycarboxylic acid polymer is excessively high, the active material is deactivated, and the capacity retention ratio tends to be easily decreased.

The content ratio of the PVdF may be 0.6% by mass or more, 0.8% by mass or more, or 1.0% by mass or more with respect to the whole mixture. In addition, the content ratio of the PVdF may be 2.4% by mass or less, 2.0% by mass or less, or 1.6% by mass or less. The upper limit and lower limit of the content ratio of the PVdF can be arbitrarily combined.

When the content ratio of the PVdF is increased with the total amount of the binder kept constant, the strength of the electrode tends to be improved.

In the binder, the amount of polycarboxylic acid polymer may be the same as that of the PVdF.

The binder can contain the various binders described above as long as the requirement (3) is satisfied.

Such a binder as described above preferably includes a styrene butadiene rubber, a polyvinylidene fluoride, and a polycarboxylic acid-based polymer, and satisfies all of the following content ratios:

Total amount of binder: 2% by mass or more and 6.0% by mass or less;

SBR: 0.8% by mass or more and 1.4% by mass or less;

Polycarboxylic acid polymer: 0.6% by mass or more and 2.4% by mass or less; and

PVdF: 0.6% by mass or more and 2.4% by mass or less.

In such an electrode film rolled web as described above, the mixture constituting the electrode film rolled web may include the active material in an amount of 94.0% by mass or more and 98.2% by mass or less and the binder in an amount of more than 1.8% by mass and 6.0% by mass or less with respect to the whole mixture.

When the mixture contains an additive such as a conductive material, the mixture may contain, with respect to the whole mixture, the additive in a ratio set by a preliminary experiment depending on the function of the additive. For example, when the mixture contains a conductive material as an additive, the mixture may include the active material in an amount of 89% by mass or more and 96.2% by mass or less, the binder in an amount of more than 1.8% by mass and 6.0% by mass or less, and the conductive material in an amount of 2% by mass or more and 5% by mass or less with respect to the whole mixture.

### [Method for Producing Electrode Film Rolled Web]

The electrode film rolled web can be produced by applying, onto a support, a slurry (coating material) obtained by dissolving or dispersing the above-described mixture in a solvent, and removing the solvent.

For the solvent, a solvent that dissolves at least the binder is used. Examples of the solvent include a hydrocarbon-based solvent, an alcohol-based solvent, an ether-based solvent, a ketone-based solvent, an ester-based solvent, an amide-based solvent, a halogen-based solvent, a sulfur-based solvent, and an inorganic solvent.

Examples of the hydrocarbon-based solvent include heptane, cyclohexane, toluene, and xylene.

Examples of the alcohol-based solvent include methanol and ethanol.

Examples of the ether-based solvent include tetrahydrofuran and dioxane.

Examples of the ketone-based solvent include acetone and methyl ethyl ketone.

Examples of the ester-based solvent include ethyl acetate and ethyl lactate.

Examples of the amide-based solvent include dimethylformamide and N-methyl-2-pyrrolidone.

Examples of the halogen-based solvent include chloroform and dichloromethane.

Examples of the sulfur-based solvent include dimethyl sulfoxide and sulfolane.

Examples of the inorganic solvent include water.

Only one of the solvents mentioned above may be used, or a mixed solvent obtained by mixing two or more of the solvents may be used.

The method for preparing the coating material is not particularly limited, but the active material, the binder, an optionally added additive, and the like may be mixed with the solvent one by one, or two or more thereof may be mixed at the same time with the solvent, and dissolved or dispersed in the solvent.

The order of adding the solid contents (active material, binder, optionally added additive) to the solvent is not limited. The insoluble component may be added to a solution obtained by dissolving the soluble component in the solvent to disperse the insoluble component in the solution. In addition, the soluble component may be added to a dispersion obtained by dispersing the insoluble component in the solvent to dissolve the soluble component in the dispersion.

After the slurry or solution is prepared, a solvent may be further added to adjust the viscosity of the coating material.

The condition of the coating material may be adjusted by a treatment such as defoaming or filtration. Additives such as an antifoaming agent, a viscosity modifier, a thickener, a diluent, a surfactant, and a stabilizer may be added to the coating material.

The method for applying the coating material is not particularly limited, and examples thereof include blade coating, dip coating, spray coating, bar coating, and die coating.

The object (support) to which the coating material is applied is preferably a release-treated resin film. The support may be a long strip-shaped support, or may be a small sheet obtained by sheet-fed processing a long support.

The object to which the coating material is applied may be a battery member such as a current collector, a separator, or a solid electrolyte. The coating material may be directly applied to these battery members to integrate coating films and the battery members.

The solvent can be removed from the coating film formed by applying the coating material to form an electrode film rolled web. The solvent can be removed by heating, depressurization, blowing, and a combination thereof.

The dried coating film may be subjected to pressing. For example, compressing the dried coating film with a pressing machine or the like can improve the contact states of particles such as the active material and conductive material included in the electrode.

In the case of using, as the support, a long strip-shaped support, the electrode film rolled web may be wound into a roll, stored, and transported, or may be further subjected to sheet-fed processing to provide a plurality of sheet-shaped electrode film rolled webs.

In this manner, the electrode film rolled web is obtained.

FIG. 3 is a schematic view illustrating an electrode film rolled web 2 according to the present embodiment.

The electrode film rolled web 2 shown in FIG. 3 has an active material layer 21 and a functional layer 22. The electrode film rolled web 2 is also sandwiched between release films 10 from both surfaces. The active material layer 21 includes, as a material, a mixture including an active material and a binder.

The electrode film rolled web 2 has no current collector.

The same mixture as the mixture constituting the electrode film rolled web 1 described above can be employed for the mixture constituting the active material layer 21.

The functional layer 22 is not particularly limited as long as the functional layer 22 is a layer attached for the purpose of improving the function of the electrode. Examples of the functional layer 22 include a heat dissipation layer, a flattening layer, a stress relaxation layer, and an adhesion layer.

The electrode film rolled web 2 also satisfies the requirements (1) to (3) mentioned above.

The electrode film rolled web 2 can be produced by preparing the active material layer 21 corresponding to the electrode film rolled web 1 in the same manner as the electrode film rolled web 1 described above, and then preparing the functional layer 22 on the surface of the active material layer 21. The functional layer 22 can be appropriately produced by a known method with the use of a known material.

The electrode film rolled web that has such a configuration as described above can provide a novel electrode film rolled web for use as a material for an electrode.

In addition, the electrode that has such a configuration as described above is self-standing and easy to handle.

### [Electrode Laminate]

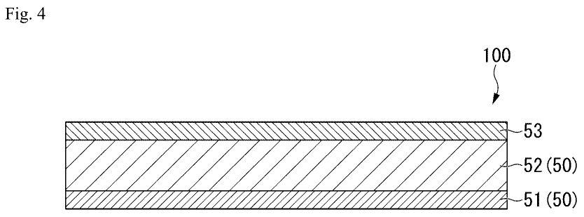

FIG. 4 is a schematic view of an electrochemical device 100 including an electrode laminate 50. The electrode laminate 50 is a laminate where the above-described electrode 51 (the electrode obtained by cutting the electrode film rolled web 1) and a layer 52 that is a separator or a solid electrolyte membrane are laminated. In the electrode laminate 50, the electrode 51 may have direct contact with the layer 52 (separator or solid electrolyte membrane), or have another member sandwiched therebetween.

The electrode laminate 50 where the layer 52 is a separator (the electrode laminate 50 including the electrode 51 and the separator) is mainly used for an electrochemical device in which an electrolytic solution is used. The electrode laminate 50 where the layer 52 is a solid electrolyte membrane (the electrode laminate 50 including the electrode 51 and the solid electrolyte membrane) is used for an all-solid-state secondary battery, which is a type of electrochemical device.

The separator is a material that insulates a positive electrode from a negative electrode and has ion permeability that is necessary for the function of the electrode. The separator is not particularly limited, and known resin films, porous membranes, and the like can be used.

Examples of the resin films include polypropylene, polyethylene, polyolefin, aramid, polyvinylidene fluoride, polyacrylonitrile, polyimide, polyamide, and polyethersulfone. For imparting ion permeability, the resin film may be made porous.

Examples of the porous membranes include a woven fabric, a nonwoven fabric, cellulose, and ceramic.

The solid electrolyte membrane is a member obtained by processing a generally known solid electrolyte into a plate or a membrane. As a material for the solid electrolyte membrane, any of generally known inorganic solid electrolytes and polymeric solid electrolytes can be used.

As the inorganic solid electrolytes, any of sulfide-based inorganic solid electrolytes, oxide-based inorganic solid electrolytes, and other lithium-based inorganic solid electrolytes can be used.

Examples of the sulfide-based inorganic solid electrolytes include Li₂S—P₂S₅, Li₂S—SiS₂, Li₂S—GeS₂, Li₂S—Al₂S₃, Li₂S—SiS₂—Li₃PO₄, Li₂S—P₂S₅—GeS₂, Li₂S—Li₂O—P₂S₅—SiS₂, Li₂S—GeS₂—P₂S₅—SiS₂, and Li₂S—SnS₂—P₂S₅—SiS₂.

Examples of the oxide-based inorganic solid electrolytes include NASICON-type materials such as LiTi₂(PO₄)₃, LiZr₂(PO₄)₃, and LiGe₂(PO₄)₃, and perovskite-type materials such as (La_{0.5+x}Li_{0.5-3x})TiO₃.

Examples of the other lithium-based inorganic solid electrolyte materials include LiPON, LiNbO₃, LiTaO₃, Li₃PO₄, LiPO₄₋ₓNₓ (x is 0<x≤1), LiN, LiI, and LISICON.

Examples of the polymeric solid electrolytes include polymer materials that exhibits ion conductivity, such as a polyethylene oxide, a polypropylene oxide, and copolymers thereof.

Examples of another member sandwiched between the electrode 51 and the layer 52 include a protective film that protects the electrode surface. The protective film is not particularly limited as long as the film is a material capable of protecting the electrode from falling off of particles such as the active material at the surface of the electrode, any excessive reaction between the electrolyte and the electrode, and the like.

### [Electrochemical Device]

The electrochemical device 100 includes the electrode laminate 50. In addition, the electrochemical device 100 also has counter electrode 53 for the electrode 51 on the opposite side of the layer 52 from the electrode 51. Examples of the electrochemical device include a secondary battery.

Examples of the secondary battery include a battery cell, a module fabricated by connecting a plurality of cells, and a pack fabricated by connecting a plurality of modules. The product of the electrochemical device may include a sensor, a control circuit, and the like for keeping abnormalities such as overcharge and overdischarge from being caused. For electrically connecting the battery to the outside, a lead (terminal) may be attached to the electrode.

The electrode laminate 50 including a separator is used as the electrochemical device 100 for a secondary battery including an electrolytic solution. Examples of the electrolyte of a lithium ion secondary battery include a solution that has a lithium salt dissolved in a nonaqueous solvent. Examples of the lithium salt include LiPF₆, LiBF₄, LiAlCl₄, LiClO₄, CF₃SO₃Li, C₄F₉SO₃Li, CF₃COOLi, (CF₃CO)₂NLi, (CF₃SO₂)₂NLi, and (C₂F₅SO₂)₂NLi. Examples of the nonaqueous solvent include carbonates (carbonate esters) such as ethylene carbonate (EC), propylene carbonate (PC), dimethyl carbonate (DMC), diethyl carbonate (DEC), and ethyl methyl carbonate (EMC).

The electrochemical device 100 can be fabricated by combining the electrode laminate mentioned above with other necessary members, for example, a separator, another electrode (counter electrode 53), and the like.

The container for housing the electrode laminate can be formed from a laminate film, metal, or the like. The electrode laminate may be disposed in a flat form in the container, or may be housed in a from such as a curved, bent, or wound form.

### [Apparatus]

A module can be fabricated by connecting a plurality of cells. A pack can be fabricated by connecting a plurality of modules. The apparatus fabricated with the use of a battery such as a cell, a module, or a pack is not particularly limited, and examples thereof include electronic apparatuses such as a smartphone, a mobile phone, a computer, and a display, and transportation apparatuses such as an electric vehicle and a hybrid vehicle.

The preferred embodiments according to the present invention have been described above with reference to the accompanying drawings, but the present invention is not limited to such examples. The various shapes, combinations, and the like of the respective constituent members shown in the examples described above are merely examples, and various modifications can be made based on design requirements and the like without departing from the gist of the present invention.

### EXAMPLES

The present invention will be described below with reference to examples, but the present invention is not limited to these examples.

The respective materials used in examples and comparative examples are as follows.

### (Binder)

SBR: styrene-butadiene rubber, manufactured by Sigma-Aldrich, model number 182877

PVdF: polyvinylidene fluoride, manufactured by Solvay, model number 5130

PAA: polyacrylic acid, manufactured by FUJIMORI KOGYO CO., LTD., model number TR-853

### (Positive Active Material)

NCM: manufactured by Xiamen Tungsten Co., Ltd. (XTC), model number HEC400

LFP: manufactured by Formosa Lithium Iron Corp., model number SFCM30050

### (Conductive Material)

AB: acetylene black, manufactured by Imerys, model number C65T

KB: Ketjen black, manufactured by Lion Specialty Chemicals, model number EC600JD

After dissolving each of the binders in a solvent to form a solution with the following concentration, each of the binders was mixed at the ratio shown in Table 1 to obtain a binder solution.

SBR: 24% by mass toluene solution

PVdF: 6% by mass NMP (N-methyl-2-pyrrolidone) solution

PAA: 40% by mass ethyl acetate solution

The active material and the conductive material were mixed at the ratio shown in Table 1 with the use of a vibration mixer to obtain a mixed powder.

The mixed powder and the binder solution were mixed at the ratio shown in Table 1 to form a slurry. Toluene was further added to adjust the viscosity.

The slurry was defoamed and passed through a sieve with a mesh size of 100 μm to obtain coating materials according to the examples and comparative examples.

The obtained coating material was applied to a release-treated PET film so as to be 3 mAh/cm². Specifically, the mass per unit area (applied mass; unit: g/cm²) of the active material was calculated from the target capacity of the electrode and the specific capacity (unit: mAh/g) of the active material to be used, and the coating material was then applied. The coating film was dried by heating at 120° C. for 12 minutes. The layer dried by compressing the dried coating film with a roll press machine was 2.4 g/cm³ (LFP) or 3.1 g/cm³ (NCM) in density, thereby providing electrode film rolled webs according to the examples and comparative examples.

The manufacturer's nominal value of the active material used was used for the specific capacity of the active material.

### [Measurement of Breaking Strength and Elongation Percentage]

The breaking strength and elongation percentage of the electrode film rolled web were measured by the method described above in (Method for Measuring Breaking Strength and Elongation Percentage).

### [Bending Test]

The bending test for the electrode film rolled web was performed by the method described above in (Bending Test).

### [Fabrication of Battery: Electrode Film Rolled Web Including Positive Active Material]

From the electrode film rolled web, a positive electrode for the coin-type battery R2032 was cut out.

The respective members were vacuum-dried at 105° C., and then assembled in a glove box in an argon atmosphere.

On a lower lid for the coin-type battery R2032, the prepared test electrode was disposed. On the test electrode, a separator (Celgard 2300 manufactured by Celgard) was disposed, and then, an electrolytic solution (1 mol/L solution of LiPF₆) was injected. As a solvent for the electrolytic solution, a mixed solvent obtained by mixing an ethylene carbonate, a diethyl carbonate, and an ethyl methyl carbonate at 1:1:1 (volume ratio) was used.

On the separator, a counter electrode (metal lithium) was disposed, and covered with a lid, and then, the whole was left to stand for 12 hours to immerse the whole in the electrolytic solution, thereby fabricating a lithium secondary battery.

### [Capacity Retention Ratio]

The fabricated lithium secondary battery was charged to 3.80 (LFP) or 4.25 (NCM) V (SOC 100%) at 0.05 C, and rested for 5 minutes. Thereafter, the battery was subjected to constant current discharge at 0.05 C, and the discharge capacity in the constant current discharge was determined. The determination was continuously performed three times, and the arithmetic mean value of the first, second, and third discharge capacities was defined as a “discharge capacity at 0.05 C” (reference capacity) (1 C=3 mA/cm²).

In addition, the “discharge capacity at 0.6 C” was determined with the use of the same battery as the lithium secondary battery for which the “discharge capacity at 0.05 C” was determined, under the same conditions mentioned above except that the battery was subjected to constant current discharge at 0.6 C.

### (Calculation Method)

The capacity retention ratio was determined from the following formula:

$$Capacity retention ratio = discharge capacity at 0.6 C / discharge capacity at 0.05 C \times 100 \%$$

The evaluation results are shown in Tables 1 and 2. Table 1 shows the results of using the NCM as the active material, and Table 2 shows the results of using the LFP as the active material. In the tables, the term “unmeasurable” for the breaking strength means that the test piece was too brittle to be subjected to the measurement. For the test piece for which the breaking strength was unmeasurable, the elongation percentage also failed to be measured.

TABLE 1

| | | | | | | | | | | | Capacity |
|---|---|---|---|---|---|---|---|---|---|---|---|
| | | | | | | | | Mechanical Strength | | | Retention |
| | Active | Conductive | | Binder | | | | Breaking | Elongation | | Ratio |
| | Material | Material | | | | | Total | Strength | Percentage | Bending | %, |
| | NCM | AB | KB | PVdF | SBR | PAA | Amount | (MPa) | (%) | Test | 0.6 C/0.05 C |
| Example 1-1 | 94.0 | 3.0 | — | 1.0 | 1.0 | 1.0 | 3.0 | 0.70 | 3.7 | ∘ | 88% |
| Example 1-2 | 90.4 | 3.0 | 0.6 | 2.4 | 1.2 | 2.4 | 6.0 | 1.12 | 7.4 | ∘ | 70% |
| Example 1-3 | 94.9 | 2.4 | 0.3 | 0.6 | 1.2 | 0.6 | 2.4 | 0.58 | 4.3 | ∘ | 77% |
| Example 1-4 | 94.0 | 2.7 | 0.3 | 1.0 | 1.0 | 1.0 | 3.0 | 0.65 | 4.6 | ∘ | 92% |
| Example 1-5 | 94.0 | 2.4 | 0.6 | 1.0 | 1.0 | 1.0 | 3.0 | 0.61 | 4.8 | ∘ | 83% |
| Example 1-6 | 94.6 | 1.8 | 0.6 | 1.0 | 1.0 | 1.0 | 3.0 | 0.73 | 5.1 | ∘ | 81% |
| Comparative | 97.0 | 1.8 | — | 1.2 | — | — | 1.2 | unmeasurable | — | x | 78% |
| Example 1-1 | | | | | | | | | | | |
| Comparative | 96.1 | 1.8 | 0.3 | 0.6 | 0.6 | 0.6 | 1.8 | 0.32 | 3.0 | ∘ | 86% |
| Example 1-2 | | | | | | | | | | | |
| Comparative | 94.0 | 2.7 | 0.3 | 1.5 | 1.5 | — | 3.0 | 0.92 | 2.9 | ∘ | 82% |
| Example 1-3 | | | | | | | | | | | |
| Comparative | 95.2 | 2.4 | — | 0.3 | 1.8 | 0.3 | 2.4 | 0.87 | 3.2 | ∘ | 33% |
| Example 1-4 | | | | | | | | | | | |
| Comparative | 95.2 | 1.8 | 0.6 | 0.3 | 1.8 | 0.3 | 2.4 | 0.76 | 2.5 | ∘ | 54% |
| Example 1-5 | | | | | | | | | | | |

TABLE 2

| | | | | | | | | | | | Capacity |
|---|---|---|---|---|---|---|---|---|---|---|---|
| | | | | | | | | Mechanical Strength | | | Retention |
| | Active | Conductive | | Binder | | | | Breaking | Elongation | | Ratio |
| | Material | Material | | | | | Total | Strength | Percentage | Bending | %, |
| | LFP | AB | KB | PVdF | SBR | PAA | Amount | (MPa) | (%) | Test | 0.6 C/0.05 C |
| Example 2-1 | 93.4 | 2.4 | 0.6 | 1.2 | 1.2 | 1.2 | 3.6 | 1.25 | 5.9 | ∘ | 85% |
| Comparative | 93.8 | 3.4 | — | 2.8 | — | — | 2.8 | unmeasurable | — | x | 26% |
| Example 2-1 | | | | | | | | | | | |
| Comparative | 93.8 | 3.4 | — | 1.4 | 1.4 | — | 2.8 | 0.88 | 2.3 | ∘ | 76% |
| Example 2-2 | | | | | | | | | | | |

The test electrode prepared from each of the electrode film rolled webs, which is chargeable and dischargeable in the coin cell for the measurement, is thus found to function as an electrode of each of the coin cells for the measurement. It has been successfully confirmed that the electrode film rolled web according to the present embodiment is just cut to be usable as an electrode.

In addition, it has been successfully confirmed that each of the electrode film rolled webs excluding Comparative Examples 1-1 and 2-1 can be self-standing, and is easy to handle, while the breaking strength and elongation percentage satisfy the requirement (1). It has been successfully confirmed that the elongation percentage of the electrode film rolled web that satisfies the requirements (2) and (3) satisfies the requirement (1).

From the foregoing results, the present invention has been found to be useful.

### DESCRIPTION OF THE REFERENCE NUMERALS

1,2 Electrode film rolled web
10 Release film
21 Active material layer
22 Functional layer
50 Electrode laminate
51 Electrode
52 Layer (separator or solid electrolyte membrane)
100 Electrochemical device

What is claimed is:

1. An electrode film rolled web comprising a mixture including an active material and a binder, wherein the electrode film rolled web satisfies the following (1) to (3):
(1) a breaking strength determined by the following measurement method is 0.35 MPa or more, and an elongation percentage is 3% or more at the breaking strength:
(Measurement Method) a strength of 75% of a maximum stress is defined as breaking strength, when a test piece obtained by cutting the electrode film rolled web into a size of 15 mm in width and 50 mm in length is measured under conditions of inter-chuck distance: 30 mm and tensile speed: 100 mm/min;
(2) the binder contains a styrene butadiene rubber, a polyvinylidene fluoride, and a polycarboxylic acid polymer; and
(3) the binder satisfies all of the following content ratios with respect to the whole mixture:
Total amount of binder: more than 1.8% by mass and 6.5% by mass or less;
Styrene butadiene rubber: more than 0.6% by mass and 1.5% by mass or less; and
Polycarboxylic acid polymer: 0.4% by mass or more and 2.6% by mass or less.

2. The electrode film rolled web according to claim 1, wherein the mixture includes a conductive material in an amount of 2% by mass or more and 5% by mass or less with respect to the whole mixture.

3. The electrode film rolled web according to claim 1, wherein the polycarboxylic acid polymer is a poly(meth)acrylic acid.

4. The electrode film rolled web according to claim 1, wherein a release film is laminated.

5. An electrode comprising the electrode film rolled web according to claim 1 as a material.

6. An electrode laminate
wherein the electrode according to claim 5, and
a separator or a solid electrolyte membrane are laminated.

7. An electrochemical device comprising the electrode laminate according to claim 6.

8. An apparatus comprising the electrochemical device according to claim 7.

9. An electrode film rolled web comprising an active material layer including, as a material, a mixture including an active material and a binder, and
comprising no current collector,
wherein the electrode film rolled web satisfies the following (1) to (3):
(1) a breaking strength determined by the following measurement method is 0.35 MPa or more, and an elongation percentage is 3% or more at the breaking strength:
(Measurement Method) a strength of 75% of a maximum stress is defined as breaking strength, when a test piece obtained by cutting the electrode film rolled web into a size of 15 mm in width and 50 mm in length is measured under conditions of inter-chuck distance: 30 mm and tensile speed: 100 mm/min;
(2) the binder contains a styrene butadiene rubber, a polyvinylidene fluoride, and a polycarboxylic acid polymer; and
(3) the binder satisfies all of the following content ratios with respect to the whole mixture:
Total amount of binder: more than 1.8% by mass and 6.5% by mass or less;
Styrene butadiene rubber: more than 0.6% by mass and 1.5% by mass or less; and
Polycarboxylic acid polymer: 0.4% by mass or more and 2.6% by mass or less.

10. The electrode film rolled web according to claim 9, wherein the mixture includes a conductive material in an amount of 2% by mass or more and 5% by mass or less with respect to the whole mixture.

11. The electrode film rolled web according to claim 9, wherein the polycarboxylic acid polymer is a poly(meth)acrylic acid.

12. The electrode film rolled web according to claim 9, wherein a release film is laminated.

13. An electrode comprising the electrode film rolled web according to claim 9 as a material.

14. An electrode laminate
wherein the electrode according to claim 13, and
a separator or a solid electrolyte membrane are laminated.

15. An electrochemical device comprising the electrode laminate according to claim 14.

16. An apparatus comprising the electrochemical device according to claim 15.
